(19) United States
(12) Patent Application Publication
(10) Pub. No.: US 2014/0233172 A1
(43) Pub. Date: Aug. 21, 2014

(54) Universal Docking Station

(71) Applicant: William F. Ryann, San Antonio, TX (US)

(72) Inventor: William F. Ryann, San Antonio, TX (US)

(21) Appl. No.: 14/223,660

(22) Filed: Mar. 24, 2014

Related U.S. Application Data
(63) Continuation-in-part of application No. 11/582,595, filed on Oct. 18, 2006, now Pat. No. 8,682,387.

(51) Int. Cl. H04B 5/00; H01F 38/14

(52) U.S. Cl. CPC H04B 5/0037; H01F 38/14
USPC 361/679.43; 361/679.41

(57) ABSTRACT

A mobile device interface platform, often referred to as a ‘docking station’. The docking station is universal in that a variety of different types, sizes and configurations of mobile devices may be immobily retained by the same engagement mechanism of the station. Where wireless mobile devices are accommodated by the docking station, the latitudinal reception affords a user a degree of imprecise placement and allows any number of wireless device types to be employed without regard to precise pin configurations or other non-wireless communicative coupling features. Nevertheless, a physically secure unitary association of the mobile device and docking station is present allowing for a functional and user-friendly manner of employing them together. The docking station may be employed for wirelessly acquiring data from the secured mobile device, sending data thereto, or even for wirelessly providing a power supply thereto.

### PRIORITY CLAIM

This Patent Document is a Continuation-In-Part claiming priority under 35 U.S.C. §120 to U.S. application Ser. No. 11/582,595, Mobile Device Interface Platform (William F. Ryann), filed Oct. 18, 2006, which is incorporated herein by reference herein in its entirety.

### BACKGROUND

A mobile device such as a smartphone may be coupled to a stationary apparatus such as a computer or car stereo through an adapter cable. Thus, music or other data stored on the device may be transferred to the stationary apparatus. In a specific example, a car stereo may then be used to play the music stored on the smartphone. Use of such a cable, however, fails to provide substantial physical security between the mobile device and the stationary apparatus. That is, unlike a compact disc inserted into the car stereo, the smartphone remains largely disassociated from the stereo in a physical sense. Thus, the practical utility of physically associating the smartphone with the car stereo is lacking, perhaps leaving the device optionally strewn about the car.

In order to provide a less cumbersome and more physically unitary coupling between the mobile device and the stationary apparatus, a mobile device interface platform (MDIP) may be employed that is integral with the stationary apparatus. For example, a stationary apparatus in the form of a car stereo or desktop computer may be provided with a built in MDIP or ‘docking station’ as it may be referred to herein. In the case of a desktop computer, the docking station may be integral with the main body or base of the more stationary computer. The docking station may serve as the interface platform for receiving and securing a mobile device such as a particular type of media player (such as an iPod or iPhone manufactured by Apple Computer of Cupertino, Calif.).

Where the docking station is integral with the stationary apparatus in the manner described above, the physical coupling of the mobile device to the stationary apparatus securely anchors the mobile device directly at the stationary apparatus. This more physically secure and unitary association of the mobile device and stationary apparatus provides a much functional and user-friendly manner of employing them together.

Unfortunately, the above-described integral docking stations are generally configured for a particular type or brand of mobile device, such as the above-noted iPods or iPhones, to the exclusion of all others. Unlike other forms of media storage such as CD's, cassette tapes, and DVD's, there is presently a significant lack of physical uniformity in accepted versions of many digital and/or powered mobile devices. That is, a multitude of smartphones and other combined media, storage, and/or communication devices presently exist with no apparent end in sight to their physical configurations or their individually unique coupling features (i.e. USB interfaces, serial ports, pin configurations, etc., all of which may be referenced herein interchangeably as pin type coupling). Thus, there is similarly no end in sight to the variety of integral docking stations that would need to be provided at a stationary apparatus in order to ensure that it would be able to couple with a randomly selected one of these mobile devices in a physically secure manner.

At present, stationary apparatuses either securely accommodate select mobile types to the exclusion of all others or simply fail to provide integral physical security between the mobile device and the stationary apparatus altogether. The severity of this problem is exacerbated by the fact that powered mobile devices in particular continue to grow in terms of usage and functionality. To wit, access to a user's mobile device is increasingly becoming the primary means of access to that particular user's pictures, music, financial and other personal information.

By the same token, coupling or docking for the sake of powering or recharging the mobile device faces the same challenges in terms of compatibility. In fact, even in the case of unintelligent mobile devices, where only power may be sought from the stationary apparatus, the user is left with relatively cumbersome powered coupling options. For example, a car cigarette lighter socket may be used to accommodate a power cable running to a variety of mobile devices such as rechargeable flashlights, power tools or a host of other such devices. Nevertheless, even with such unintelligent devices, the cumbersome cable remains.

### SUMMARY

A docking station is provided that includes structure which defines a cavity. The structure and cavity may be configured to at least partially receive and immobilize one of a variety of differently sized data storing mobile devices. Once more, the immobilization may be achieved in a pin-free positionally imprecise manner and in a fashion allowing wireless power transfer thereto.

In an embodiment of a docking system, one of a variety of differently dimensioned data storing mobile devices may be provided with a stationary apparatus configured to wirelessly transfer power to the device during docking thereof. A docking station of the stationary apparatus may be provided to support the docking in a pin-free positionally imprecise manner.

A method is provided where one of a variety of differently sized data storing mobile devices may be received within a cavity of a docking station. Additionally, the mobile device may be immobilized within the cavity to achieve docking thereof in a pin-free positionally imprecise manner. Once immobilized, power may be wirelessly transferred from the docking station to the device.

### BRIEF DESCRIPTION OF THE DRAWINGS

FIG. 1 is an exploded perspective view of an embodiment of a universal docking station as part of a stationary assembly to accommodate a mobile device.

FIG. 2 is a side cross-sectional view of an embodiment of an engagement mechanism of the docking station taken from section lines 2-2 of FIG. 1.

FIG. 3 is a perspective view of an embodiment of an engagement actuator of the docking station of FIG. 1.

FIG. 4 is a side cross-sectional view of the engagement mechanism of FIG. 2 securing the mobile device of FIG. 1.

FIG. 5 is a top cross-sectional view of the engagement mechanism of FIG. 2 securing the mobile device of FIG. 1.

FIG. 6 is a flow chart summarizing an embodiment of coupling a mobile device to a mobile device interface platform.

FIG. 7 is a front perspective view of the docking station of FIG. 1 securing the mobile device of FIG. 1.

FIG. 8 is a cross-sectional view of an embodiment of an engagement mechanism of the docking station for power transfer to a mobile device.

FIG. 9 is an enlarged view of the engagement mechanism taken from 9-9 of FIG. 8, and depicting wireless power transfer to the mobile device.

FIG. 10 is a perspective view of alternate embodiments of multiple engagement mechanisms of a docking station for powerably accommodating differing mobile device types.

FIG. 11 is a side view of another alternate embodiment of docking station and engagement mechanism for powerably accommodating additional differing mobile device types such as overhead lights.

### DETAILED DESCRIPTION

Embodiments of a mobile device interface platform (MDIP), often referred to herein as a ‘docking station’, are described with reference to certain mobile device and stationary apparatus types. For example, a stationary apparatus in the form of a car stereo and a powered mobile device storing digital audio data are referenced throughout. Regardless, embodiments disclosed provide a mobile device interface platform integral with the stationary apparatus and having an engagement mechanism capable of stably and immobily accommodating a mobile device. Specifically, the engagement mechanism may include structure defining a cavity for accommodating any of a variety of mobile device shapes, sizes, types, and configurations. Accordingly, in a relative sense, such embodiments may serve as universal docking stations. Additionally, embodiments described may be of particular benefit where powered or communicative coupling is to be employed in a wireless manner.

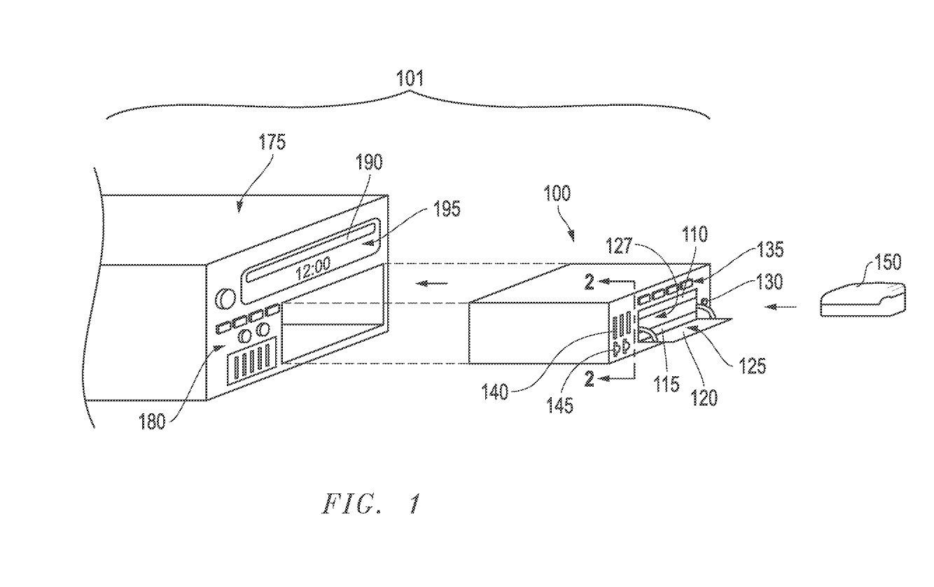

Referring now to FIG. 1, an embodiment of a mobile device interface platform (docking station) 100 is shown as part of a docking assembly 101. The docking station 100 includes an engagement mechanism 125 to both latitudinally receive and physically retain a mobile device 150 in a substantially immobile fashion. This mechanism 125 includes the structure defining the cavity that receives the device 150 and secures it in the pin-free positionally imprecise manner detailed herein. The docking assembly 101 also includes a stationary apparatus 175 for obtaining data from the mobile device 150. In one embodiment, the stationary apparatus 175 may also be configured for uploading data to the mobile device 150. Additionally, as shown, the stationary apparatus 175 is configured for integrally coupling with the docking station 100. Indeed, in one embodiment, the docking station 100 and the stationary apparatus 175 may be of a unitary configuration with no visible separation therebetween. In an alternate embodiment, however, the docking station 100 may be more of a stand-alone unit that is wired or wirelessly coupled to the stationary apparatus 175. Regardless, as described below, the docking station 100 is also provided with an engagement mechanism 125 as part of the docking assembly 101.

In the embodiment shown in FIG. 1, the docking assembly 101 includes a stationary apparatus 175 in the form of a car stereo. Thus, a car stereo control panel 180, clock face 195, compact disc slot 190 and other conventional car stereo features may be present. However, in alternative embodiments, the stationary apparatus 175 may be a laptop computer, desktop computer, control panel, home stereo, entertainment system, television, navigation system, or a host of other apparatus types.

Continuing with reference to FIG. 1, embodiments described herein include a stationary apparatus 175 that is of a less personally mobile character than the mobile device 150. Thus, the docking station 100 serves as a functional and user-friendly interface therebetween. For example, in the embodiment shown, the mobile device 150 may be a cell phone or smartphone with audio (e.g. MP3) data stored therein. Similarly, the device 150 may be any of a variety of differently sized or shaped smartphones or small tablet-type computing or communicative devices (i.e. “phablets”). Continuing with reference to this embodiment, the stationary apparatus 175 is a car stereo as noted. In such an embodiment, the car stereo is designated as the stanionary apparatus 175 even though it may have some degree of mobility in as much as it is for use in an automobile and may be transported about. That said, a mobile device 150 in the form of a smartphone may naturally be considered of greater mobility in a relative sense given its configuration for transport and use on person. Stated another way, while virtually any consumer electronic device may be characterized as having some degree of mobility, the embodiments described herein include a mobile device 150 that is of greater personal mobility for a user than the stationary apparatus 175 to which it may be coupled or associated.

As indicated above, a mobile device 150 of comparatively greater mobility is present in the form of a smartphone with audio data stored thereon. However, in other embodiments, the mobile device 150 may be a conventional audio player, flash device, pc card, handheld or other personal carriage digital device, or a variety of other data storage devices. Further, such a mobile device 150 may include its own independent power source and/or be configured for powered coupling to the docking station 100 or stationary apparatus 175 as described further herein.

As shown in FIG. 1, the docking station 100 may be integrally coupled to the stationary apparatus 175 providing a docking assembly 101 of unitary configuration. Thus, even in circumstances where the stationary apparatus 175 is a car stereo or other potentially semi-mobile device, the docking station 100 may remain integrally coupled to the stationary apparatus 175 during use. As a result, integral physical security is provided between the stationary apparatus 175 and any mobile device 150 that is itself retained by the docking station 100 as described below.

In the embodiments described herein, the mobile device 150 is latitudinally received by the engagement mechanism 125 of the docking station 100. That is, in one embodiment, the mobile device 150 may be loosely received within a cavity 127 defined by the engagement mechanism 125 such that a significant degree of play may be present between the mobile device 150 and the engagement mechanism 125. Thus, when a door 120 to the cavity 127 is open as shown in FIG. 1, the engagement mechanism 125 may receive and accommodate a variety of mobile device sizes and shapes.

As indicated above, a mobile device 150 may be any of a variety of data storage devices, including powered devices such as the smartphone with audio data stored thereon as shown in FIGS. 1-5, and 7. In the embodiments shown, the smartphone mobile device 150 is of a clamshell configuration. However, the mobile device 150 may be of unitary construction not configured for physically expanding by opening and closing. As indicated, the mobile device 150 may be a host of other devices such as MP3 players, flash storage devices, pc cards, and a variety of handheld data storage devices, some of which may even display a degree of ergonomic design for user-friendly functionality. Generally, such mobile devices 150 range from about 0.75 inches to about 3.0 inches wide by between about 2.75 inches to about 5.0 inches in length and have a profile of between about 0.25 inches and about 1.0 inch. However, larger, and in some instances even smaller, mobile devices 150 may be employed.

Embodiments of the mobile device 150 may be of significantly differing physical character from one mobile device 150 to the next. This physical character may differ from one mobile device 150 to the next in terms of mobile device size (i.e. dimensionally). Alternatively, the differing physical character may also be in terms of mobile device shape or configuration (e.g. clamshell phone versus slide phone). Nevertheless, a single engagement mechanism 125 may be employed to accommodate any of a variety of mobile devices of significantly differing physical character.

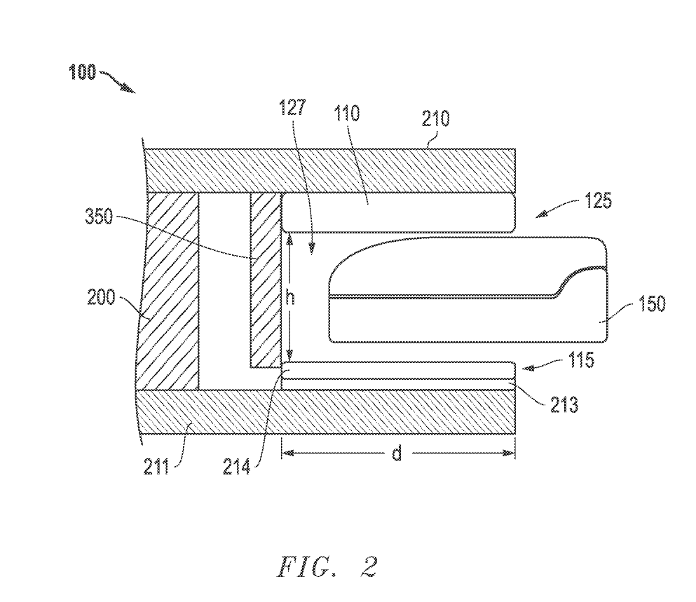

Continuing with reference to FIGS. 1 and 2, the engagement mechanism 125 of the docking station 100 is configured to latitudinally receive the mobile device 150 as described above. Furthermore, it is also configured to physically retain or secure the mobile device 150 in a stable and/or immobile manner. In the embodiments shown, this may be achieved by a clamping or compression action of retention members in the form of a lower compression member 115 against an upper compression member 110 once the mobile device 150 is inserted into the cavity 127. Thus, in order to subsequently remove the mobile device 150, an eject button 130 is also shown in the embodiment of FIG. 1 to actuate decompression of the compression members 110, 115 relative to one another. Of course, the members 110, 115 may be retention members of another variety. That is, they need not substantially “compress” in order to achieve retention. For example, magnetism, hook and loop, inflation or other types of retention may be utilized by the members 110, 115 or as a supplement thereto. Furthermore, in addition to the engagement mechanism 125, the docking station 100 of FIG. 1 reveals other features such as a docking station 100 control panel 135 and supplemental device coupling features which may include USB ports 140 or power sockets 145 also detailed further herein.

Referring more specifically now to FIG. 2, a side cross-sectional view of an embodiment of the engagement mechanism 125 of the docking station 100 of FIG. 1 is shown. With reference to this view, latitudinal reception of the mobile device 150 by the engagement mechanism 125 is described below. Of note is the fact that in the embodiments shown, the latitudinal reception capacity of the engagement mechanism 125 is a function of height (h) and width (w) of the cavity 127 (without reference to the depth (d) thereof).

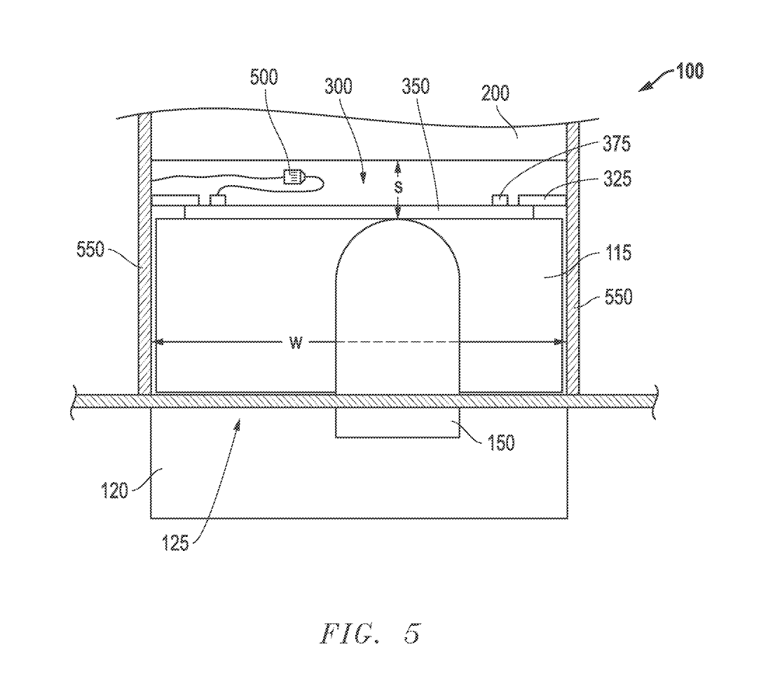

As shown in FIG. 2, as the mobile device 150 is inserted into the cavity 127 of the engagement mechanism 125, it is apparent that the height (h) between the upper and lower compression members 110, 115, is more than enough to provide clearance for the insertion of the mobile device 150. Similarly, a width (w) across the cavity 127 may be provided that is likewise more than enough to provide clearance for the insertion of the mobile device 150 (see FIG. 5). Thus, latitudinal reception of the mobile device 150 is provided. In fact, given a deformable nature of at least one of the compression members 110, 115, even a mobile device 150 having a profile roughly equivalent to the height (h) may be latitudinally received, given the amount of play provided by such a compression member 110, 115.

Continuing with reference to FIG. 2, and with added reference to FIG. 5, the latitudinal reception capacity of the engagement mechanism 125 in terms of height (h) and width (w) is further detailed. With particular reference to FIG. 2, it is apparent that the height (h) of the cavity 127 to accommodate the profile or height of the mobile device 150 is defined by the distance between the upper and lower compression members 110, 115. Thus, in order to ensure that the profile of the mobile device 150 is latitudinally received by the height (h) of the cavity 127, the height (h) is configured with a range of potential mobile device 150 profiles in mind. For example, as indicated above, embodiments of the mobile device 150 may have a profile or height of between about 0.25 inches and about 1.0 inches. Therefore, in one embodiment of the height (h) of the cavity 127 is between about 0.75 inches and about 1.25 inches, preferably about 1 inch. In this manner, a wide variety, if not most, mobile device 150 types, may be latitudinally received within the cavity 127 in terms of height.

With brief added reference to FIG. 5, described in further detail below, it is apparent that the width (w) of the cavity 127 to accommodate the width of the mobile device 150 is defined by the sidewalls 550 of the engagement mechanism 125. Thus, similar to the height (h) configuration described above, the width (w) of the cavity 127 is configured with a range of likely mobile device 150 widths in mind in order to ensure that the width of the mobile device 150 is latitudinally received by the width (w) of the cavity 127. For example, as also indicated above, embodiments of the mobile device 150 may have a width of between about 0.75 inches and about 3.0 inches. Therefore, in one embodiment the width (w) of the cavity 127 is between about 1.0 inch and about 5.0 inches, preferably at least about 2.0 inches wide. In an embodiment where the width (w) is between about 2.0 inches and about 3.0 inches a wide variety, if not most, mobile device 150 types, may be latitudinally received within the cavity 127 in terms of their width.

continuing with reference to FIGS. 2 and 5, where space permits for the docking assembly 101, the width (w) may be greater than about 3.0 inches (see FIG. 1). That is, the overall footprint of the engagement mechanism 125 at the surface of the assembly 101 may be less affected by the width of the engagement mechanism 125 (again see FIG. 1). Hence, in certain embodiments the width (w) of the cavity 127 may be oversized where desired. In fact, in the embodiment shown in FIG. 5, the mobile device 150 may be between about 2.0 inches and about 3.0 inches wide. Nevertheless, the width (w) of the cavity 127 may be between about 4.5 and about 5.5 inches wide. Thus, any one of substantially every common mobile device 150 type, including the one shown in FIG. 5, may be latitudinally received within the cavity 127 in terms of device width. Similar to a conventional CD slot, such as the compact disc slot 190 of the stationary apparatus 175, this may be achieved without significant sacrifice to surface space of the assembly 101 (see FIG. 1). Further, such an oversized width (w) may provide for more of a user-friendly access to the engagement mechanism 125.

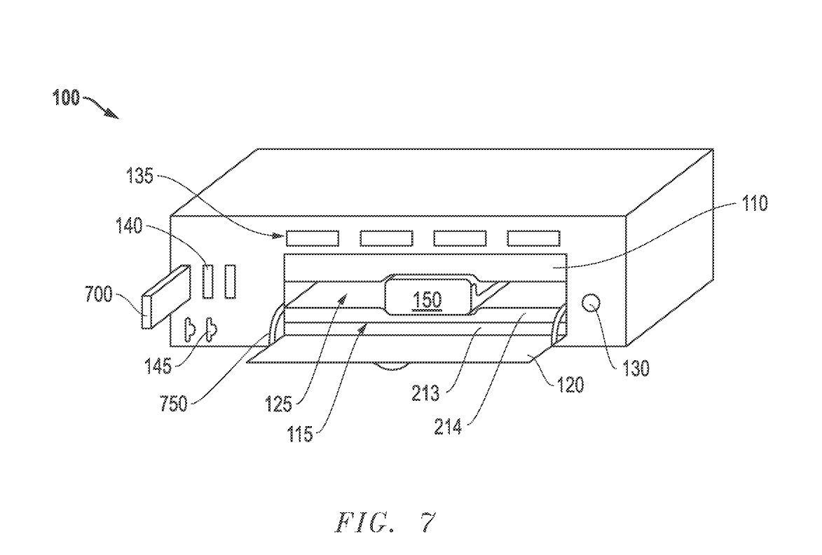

In the embodiments shown, the latitudinal reception of the mobile device 150 is achieved with the door 120 of the docking station 100 opened (see FIGS. 1 and 7). Thus, as indicated above, the depth (d) of the cavity 127 fails to play a role in the latitudinal reception capacity of the engagement mechanism 125. However, in other embodiments where the mobile device 150 is to be fully encased or enclosed within the cavity 127, all dimensions, including depth (d), may be configured to ensure substantially complete latitudinal reception of the mobile device 150.

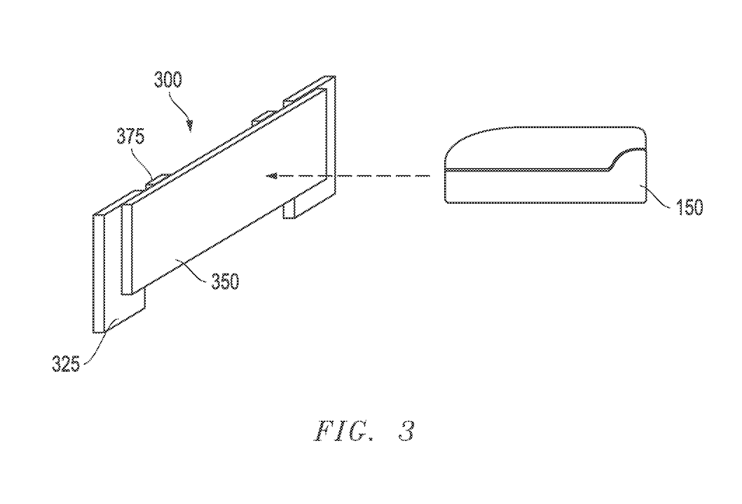

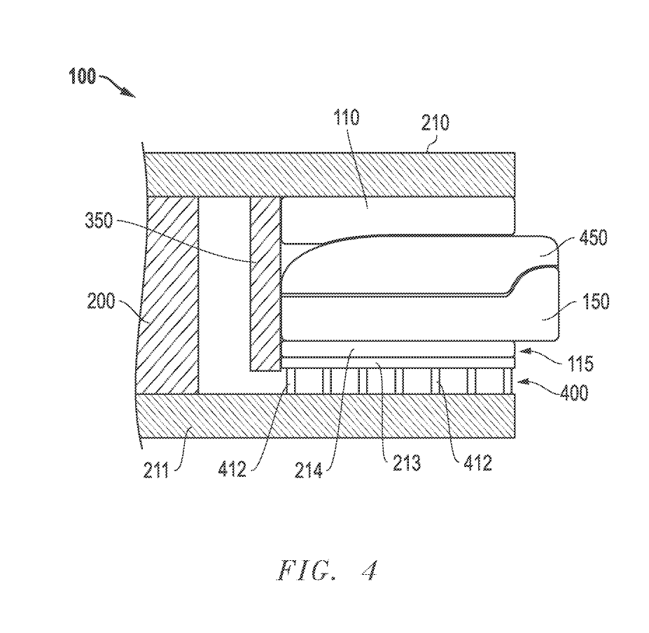

Continuing with reference to FIGS. 2 and 5, the above noted cavity 127 is defined in terms of its height (h) between the compression members 110, 115 prior to actuation of compression (see discussion below relative to FIGS. 3 and 4 regarding actuation of compression). The width (w) of the cavity 127 is defined by the distance between the sidewalls 550 of the engagement mechanism 125. Furthermore, although not determinative of latitudinal reception capacity in the embodiments shown, the depth (d) of the cavity 127 is noted herein as the distance from the entrance of doorway to the cavity 127 (at a door 120) to a beam 350 opposite the entrance. As described below, this beam 350 may act as a backstop for the entering mobile device 150 in addition to providing detection information relative to the position of the mobile device 150.

A component housing 200 including a wireless receiver may be located adjacent the above described beam 350. Thus, positioning of the mobile device 150 in contact with the beam 350 may help ensure the wireless coupling of the mobile device 150 to wireless features of the component housing 200. The wireless platform may be a conventional Bluetooth platform. Additionally, the wireless nature of such a coupling may allow avoidance of precise device 150 positioning, as might otherwise be required by the use of a pin pattern configuration or other non-wireless communicative coupling. That is, coupling may be achieved in a pin-free positionally imprecise manner without regard to a particular USB shaped protrusion, prong, serial port arrangement, pin configuration or other physically precise matched pairing. This aspect is also described in further detail with respect to FIG. 5 below.

While the cavity 127 is referenced as defined by the above noted features, the cavity 127 is not necessarily a completely sealed off enclosure. In fact, a door 120 to the cavity 127 may be open at one end when the engagement mechanism 125 is in use. Nevertheless, the above described features defining the cavity 127 provide enough continuity to allow the latitudinal reception by the engagement mechanism 125. This latitudinal reception is achieved in secure enough of a manner so as to also allow for the physical retention of the mobile device 150 upon actuation of compression of the compression members 110, 115 as described above.

Continuing with reference to FIG. 2, the upper compression member 110 may be a compliant material secured to a stationary and firm ceiling 210 of the docking station 100 whereas the lower compression member 115 may include a pad 214, also of a compliant material, coupled to a vertically movable rigid support 213. As described further below, the rigid support 213 may be raised above the floor 211 of the docking station 100 securing the mobile device 150 between the upper compression member 110 and the pad 214.

Continuing now with reference to FIGS. 2 and 3, the mobile device 150 may be inserted into the cavity 127 and toward an engagement actuator 300 of the engagement mechanism 125 at the back of the cavity 127. In the embodiments shown in FIGS. 2-5 the engagement actuator 300 is a conventional strain gauge mechanism whereby contact between the mobile device 150 and the engagement actuator 300 may be detected. As described with reference to FIG. 4 below, such detection may be employed to trigger movement of one of the compression members 110, 115 in order to immobily secure the mobile device 150 in position within the cavity 127.

With reference to FIG. 3 in particular, the engagement actuator 300 is a strain gauge mechanism, with the above noted beam 350 for contacting by the mobile device 150. This beam 350 is held in place by supports 325 and includes strain gauge sensors 375 coupled thereto. The strain gauge sensors 375 may detect movement in the beam 350 as a user forces the mobile device 150 toward the beam 350 making contact therewith. Detection information may then be relayed to a microprocessor 500 wired to the strain gauge sensors 375 in order to actuate securing of the mobile device 150 by the engagement mechanism 125 (see FIG. 5). Mechanical detection of the mobile device 150 may also be achieved by other methods including by contacting an elongated button or other actuating mechanism at the rear of the cavity 127 (see FIG. 2).

While the engagement actuator 300 is shown in the form of a mechanical sensor, other forms of sensors may be employed including optical sensors and motion sensors. In fact, sensing may even take place in a manner that identifies the particular mobile device 150 to the assembly 101, perhaps even before wireless coupling has taken place as indicated above. For example, the engagement actuator 300 may include a bar code scanners or an RFID reader in order to identify a mobile device 150 having appropriate bar code or RFID tag features. With such capacity, the RFID tag itself may be updated with data indicative of the coupling.

Continuing with reference to FIGS. 3 and 4, once the engagement actuator 300 is triggered and detection information relayed as indicated above, a lift 400 may be activated to force the lower compression member 115 upward, securing the mobile device 150 against the upper compression member 110. In the embodiment shown, the lift 400 includes a plurality of projections 412 which may be spring or hydraulically activated to raise the rigid support 213 of the lower compression member 115. As indicated above, the upper compression member 110 and the pad 214 may be of compliant materials. Thus, as the lower compression member 115 forces the mobile device 150 toward the stationary firm ceiling 210 of the docking station 100, the upper compression member 110 and the pad 214 may conform to the surface of the mobile device 150. In this manner, the mobile device 150 may be secured and retained in a cushioned fashion. Additionally, the conformal nature of the compression member 110 and the pad 214 allow the engagement mechanism 125 to secure mobile devices 150 of a wide variety of shapes and dimensions. In one embodiment, the maximum deformation or compression of the compression members 110, 115 at any given conforming area thereof may be between about 5% and about 50% in conforming to the shape and/or profile of the mobile device 150.

In one embodiment, the upper compression member 110 and the pad 214 may be of a polymer foam material. For example, conventional compressed foams and polyurethane foams may be employed of an open or closed cell variety. Further, in one embodiment, the pad 214 and upper compression member 110 may be of different materials. For example, in the embodiment shown, the pad 214 is of a lower profile, smaller pore size and denser structure than that of the upper compression member 110. In this manner, the pad 214 is configured for less deformation than the upper compression member 110 as the mobile device 150 is secured. Thus, an added degree of stability may be provided to the surface of the lower compression member 115 in comparison to the upper compression member 110. This may be of benefit given the moving and weight bearing nature of the lower compression member 115 as compared to the stationary and relatively stable upper compression member 110.

Continuing with reference to FIG. 4, and with added reference to FIG. 2, it may be of benefit to detect forces resulting from the presence or position of the mobile device 150 in the cavity 127. This may be true for detection of the mobile device 150 contacting the beam 350 at the back of the cavity 127 as indicated above. However, as indicated below, detection of other mechanical forces relative to the mobile device 150 as it is retained by the engagement mechanism 125 may also be of benefit.

In one embodiment, a conventional strain gauge mechanism similar to that above is coupled to the engagement mechanism 125 to measure forces exerted on the mobile device 150 as it is secured and retained. Such a mechanism may be incorporated into the stationary and firm ceiling 210 of the docking station 100, able to detect strain forces exerted thereon via the raising lift 400. Although detected at the ceiling 210, these will be reflective of the forces exerted on the mobile device 150 itself. The detected level of strain forces may then be relayed to a microprocessor that is coupled to the lift 400.

Upon detection of a predetermined level of strain force, such a microprocessor may direct the lift 400 to cease raising and remain stationary, effecting secure retention of the mobile device 150 in the cavity 127 without damage to the mobile device. In one embodiment, the predetermined level of strain force to cause the lift 400 to cease raising is set at between about 0.25 lbs. and about 3.0 lbs. In this manner a significant percentage of all mobile devices 150 may be securely retained without damage thereto.

Notice that the degree of ascension exhibited by the lift 400 in effecting the predetermined level of strain is a function of the profile of the mobile device 150 along with the nature and amount of compressible character in both the pad 214 and the upper compression member 110. Furthermore, since the degree of ascension exhibited by the lift 400 is determined by measurements of force as opposed to lift 400 positioning, the profile of the mobile device 150 is of minimal significance so long as it is about the height (h) of the cavity 127 or less. that is, in the embodiment shown, any of a variety of mobile devices 150 having a profile of up to about 1.0 inches (i.e. the height (h)) may be immobily and securely retained by the engagement mechanism 125 as indicated.

As indicated above, and again with added reference to FIG. 2, the depth (d), from the cavity 127 entrance to the beam 350, may not play a role in determining latitudinal reception of the mobile device 150 in embodiments shown herein. Nevertheless, the depth (d) of the cavity 127 may be configured in light of the variety of lengths of mobile devices 150 likely to be accommodated. For example, as noted above, a mobile device 150 to be accommodated by an embodiment of the docking station 100 may be between about 2.75 inches about 5.0 inches in length. In such an embodiment the mobile device 150 may be fully positioned in the cavity 127 (i.e. contacting the beam 350) while leaving an accessible portion 450 exposed for manual retrieval of the mobile device 150 from the cavity 127 following use. In such an embodiment, the engagement mechanism 125 may be configured with a depth (d) from about 1.5 inches up to about 2.75 inches, perhaps more preferably between about 2.25 inches and about 2.5 inches. In this manner, the majority of the body of such mobile devices 150 will be within the cavity 127 when positioned as indicated. Further, an accessible portion 450 of even the smallest of such mobile devices 150 will remain exposed for manual retrieval of the device 150 when positioned as indicated.

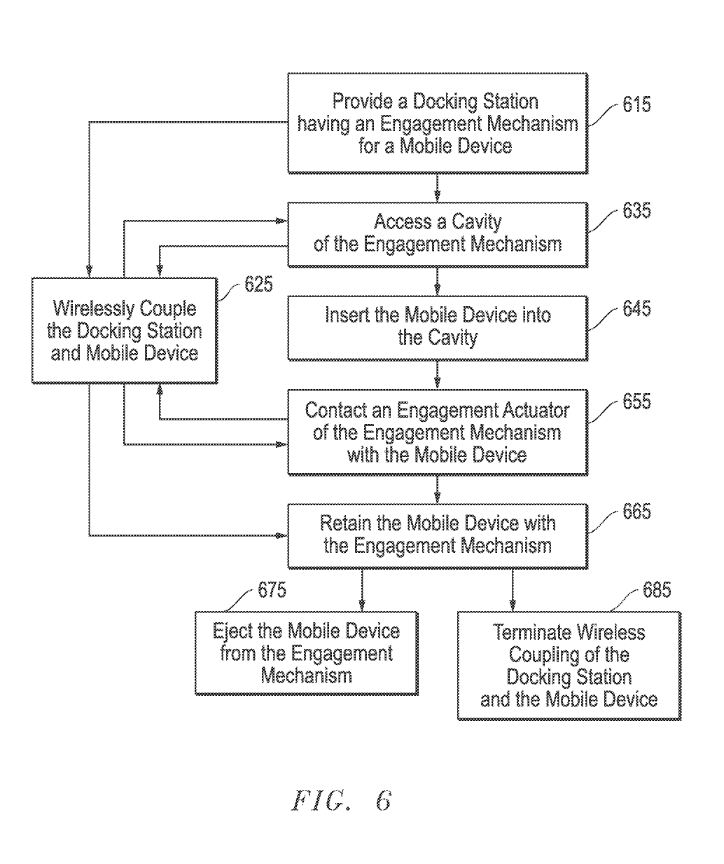

Referring now to FIGS. 5 and 6, a top cross-sectional view of a docking station 100 with engagement mechanism 125 is shown along with a flow chart summarizing an embodiment of coupling a mobile device 150 thereto. That is, a docking station 100 with engagement mechanism 125 may be provided as indicated at 615 for receiving and retaining a mobile device 150 as described below.

In the embodiment shown, a door 125 of the docking station 100 may be opened exposing a cavity 127 of the engagement mechanism 125 as indicated at 635. As noted at 645 and 655, and with added reference to FIG. 2, a mobile device 250 may be inserted into the cavity 127 until contact is made with an engagement actuator 300 at the rear of the cavity 127. As noted in the description above, a wide variety of mobile device sizes and shapes may be latitudinally received by the cavity 127 in this manner. Furthermore, the wireless nature of the embodiment shown allows for latitudinal positioning of the mobile device 150 within the cavity 127 without requiring the precise positioning that might otherwise be required where non-wireless communicative coupling, such as USB, pin configurations, or serial ports, are employed.

Contact with the engagement actuator 300 as indicated above, may be detected. In one embodiment, this detection may further include the identification of the mobile device 150 such as where a bar code reader, RFID mechanism are employed as indicated above. Alternatively, as indicated below, wireless coupling may take place at this time as indicated at 625 in order to provide identification.

The above described contact with the engagement actuator 300 may also lead to the secure retention of the mobile device 150 within the cavity 127 by the engagement mechanism 125 (see 665). Thus, a wide variety of mobile device 150 sizes and shapes may ultimately be coupled to a stationary apparatus 175 via the docking station 100 where the docking station 100 is incorporated into an assembly 101 including the stationary apparatus 175 (see FIG. 1).

With added reference to FIG. 1, at some point during the described physical coupling of the mobile device 150 to the docking station 100 and stationary apparatus 175, wireless coupling may also be attained. For example, in the embodiment shown, a mobile device 150 in the form of a smartphone with audio data stored thereon may be wirelessly coupled to a car stereo stationary apparatus 175 via the docking station 100. As indicated at 625, wireless coupling, often referred to as pairing, may be achieved by conventional means at various points in time throughout the above described physical coupling of the mobile device 150 as described below.

In one embodiment, wireless coupling takes place once the engagement mechanism 125 has retained the mobile device 150 as indicated at 665. Alternatively, wireless coupling may be initiated at a prior point in time, such as when the mobile device 150 is detected by the engagement actuator 300 as noted above and indicated at 655 or upon the user opening the door 120 of the docking station 100 as indicated at 635. In fact, wireless coupling may even take place by conventional means prior to any physical coupling of the mobile device 150 as described herein (see 615). Regardless, in the embodiment shown in FIG. 5, once the mobile device 150 is positioned adjacent the beam 350 of the engagement actuator 300, a predetermined separation (s) is all that separates the wireless mobile device 150 from a component housing 200 of the docking station 100. In one embodiment, the component housing 200 includes a wireless receiver for coupling to the mobile device 150. Thus, the features of the component housing 200 such as the wireless receiver may be configured in light of the separation (s) to ensure wireless reception there-across. In fact, in one embodiment, such a wireless receiver may be directionally or otherwise conventionally tuned to the vicinity opposite the beam 350 to help ensure substantially isolated communication with the mobile device 150.

Continuing with reference to FIGS. 5-7, a user may eject the mobile device 150 from the engagement mechanism 125 as indicated at 675 by pressing a conventional eject button 130. In this manner, decompression or descending of the lower compression member 115 may be activated through the eject button 130 by conventional means. Thus, the user may grab the accessible portion 450 of the mobile device 150 and withdraw it from the engagement mechanism 125 of the docking station 100 (see FIG. 4). Pressing of the eject button 130 may also be employed to terminate wireless coupling of the mobile device 150 and the docking station 100 as indicated at 685. However, in other embodiments, wireless coupling may be maintained even with removal of the mobile device 150.

Referring now to FIG. 7, a front perspective view of an embodiment of the docking station 100 is shown. In this embodiment, the docking station 100 and engagement mechanism 125 thereof are shown accommodating a mobile device 150. The door 120 in front of the engagement mechanism 125 is opened with stop hinges 750 holding it in position parallel with the inserted mobile device 150. At the face of the docking station 100 other features such as a control panel 135, the eject button 130, USB ports 140, and power sockets 145 are apparent.

In one embodiment, the mobile device 150 may be configured for physical coupling through the engagement mechanism 125 as described above, with additional coupling through alternate routes. For example, the mobile device 150 may lack an independent power source or be configured to draw power from an external source when available. In such an embodiment, the mobile device 150 may be wired to a power socket 145 to provide power thereto and perhaps even recharging capability (e.g. in an embodiment that is not wirelessly rechargeable as those detailed further below). Similarly, the mobile device 150 may lack wireless capacity or be configured to allow secure wired communication where available. In such an embodiment, the mobile device 150 may be wired to a USB port 140 or other communication port of the docking assembly 101 (see FIG. 1). In one embodiment, the power socket 145 itself may double as a communication port, perhaps even allowing simultaneous communication and powered coupling therethrough. Furthermore, the docking station 100 may be configured to couple to other data storage devices, such as a flash device 700, in addition to the mobile device 150. This may be of particular benefit in an embodiment where the docking station 100 is integral with a stationary apparatus 175 in the form of a car stereo to accommodate multiple sources of MP3 or other digital audio data storage devices (see FIG. 1). These devices may include a mobile device 150 in the form of a smartphone having audio data stored thereon as well as other types of audio flash devices 700 as shown in FIG. 7.

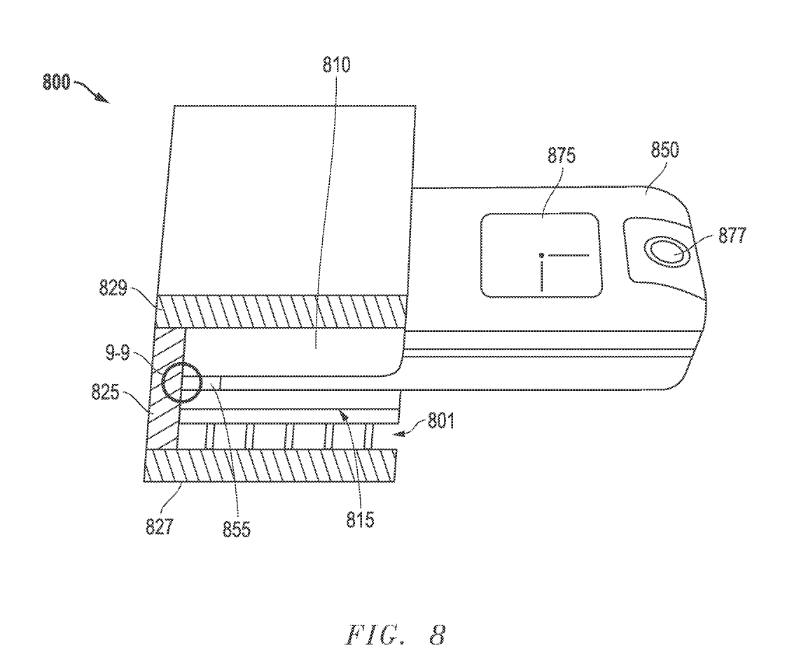

Referring now to FIGS. 8-11, embodiments of a docking station are depicted which, for sake of clarity are now referred to as a docking station 1000, 1100. In contrast, or in addition, to embodiments of FIGS. 1-7 detailed above, the embodiments of FIGS. 8-11 include features and techniques for achieving wireless power transfer from the docking station 1000, 1100 to the mobile device 850, 1050, 1150, 1151 via an engagement mechanism 800, 1001, 1175. Again, the mobile device 850, 1050, 1150, 1151 may be latitudinally received and stably and/or immobily retained by the docking station 1000, 1100 and its engagement mechanism 800, 1001, 1175.

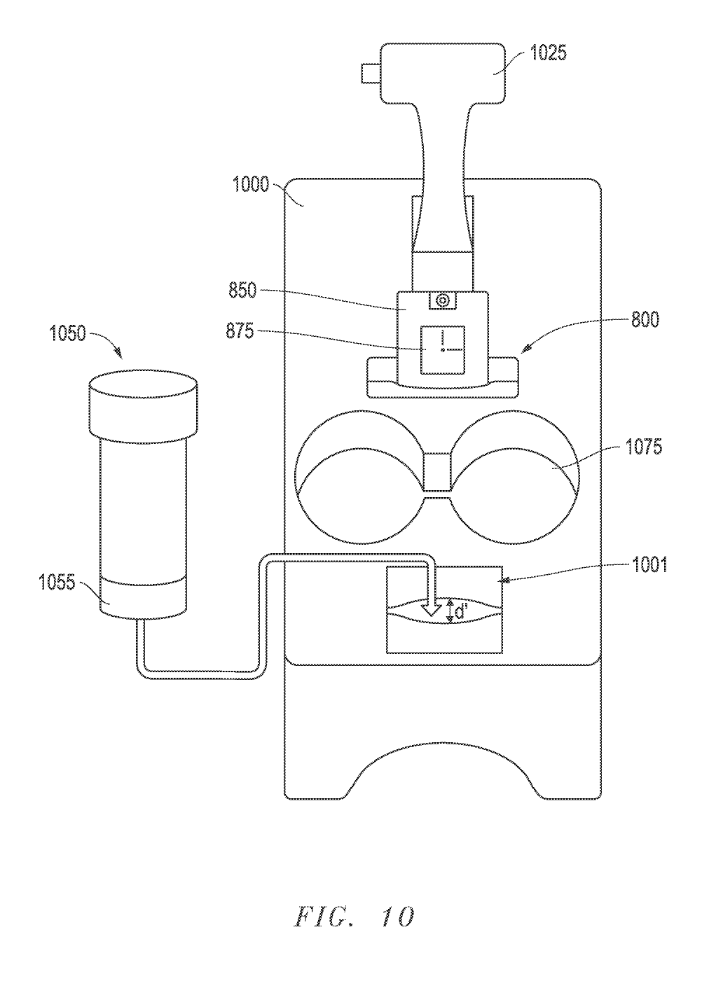

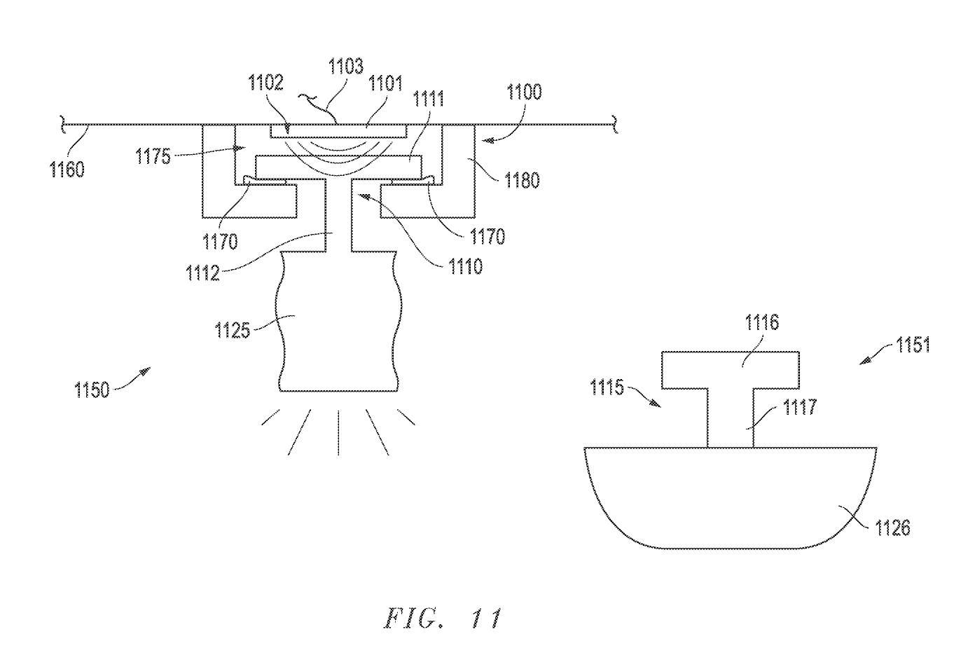

Referring specifically now to FIG. 8, with added reference to FIG. 10, a cross-sectional view of an embodiment of an engagement mechanism 800 is shown. The engagement mechanism 800 is part of a docking station 1000 which is configured to accommodate wireless power transfer to a mobile device 850 which it retains. In the embodiment shown, the mobile device 850 is a smartphone with audio data stored thereon and includes features such as a display 875 (indicating time) and a light function 877. Additionally, the docking station 1000 with mechanism 800 is provided as a vehicle console. However, stationary apparatuses other than vehicles may include such a docking station 1000. These may include home or car stereos, laptop computers, desktop computers, televisions, entertainments systems, navigation systems, a host of control panel types and even architectural platforms (see FIG. 11). Regardless, as in the embodiments of FIGS. 1-7, the stationary apparatus with docking station 1000 is of a less personally mobile character than the mobile device 850. That is, while in a relative sense, a certain degree of mobility may be said to be present in almost anything, mobile devices 850 as detailed herein are of a comparatively greater mobility than the corresponding stationary apparatuses and docking stations 1000 described.

Continuing with reference to FIG. 8, the mobile device 850 depicted is in the form of a smartphone with audio data stored thereon. However, in other embodiments the mobile device 850 may be a conventional MP3 player such as an iPod, a flash device, pc card, handheld or personal carriage digital device or a variety of other data storage devices. Additionally, comparatively unintelligent non-communicative devices such as flashlights 1050, ceiling lights 1125, 1126, motion detectors, and other mobile device types may be employed which may not be of a data storing capacity (see also FIG. 11). Of course, such devices which are traditionally unintelligent may have data storing or communicative features built thereinto. For example, a flashlight 1050 or other similar device may be equipped with data storing or capacity and be considered a data storing mobile device as described herein.

Continuing with the embodiment of FIG. 8, the smartphone 850 is of a clamshell configuration. However, the device 850 may alternatively be a slide phone or of unitary or other construction. Furthermore, given the wide range of alternative device types that may also be employed, the mobile device 850 may be of a wide variety of shapes and sizes. Nevertheless, in spite of the potential significantly differing dimensions from one device 850 to the next, a single engagement mechanism 800 may be employed to accommodate any of the variety of potential devices 850. Thus, as detailed with respect to the embodiments of FIGS. 1-7, latitudinal reception of the device 850 may be provided. Additionally, as also detailed above, within certain dimensional tolerances, the engagement mechanism 800 may be configured to stably and immobly retain the mobile device 850, irrespective of dimensional and morphological configuration or physical profile.

With particular reference to the depiction of FIG. 8, the engagement mechanism 800 is shown retaining the described mobile device 850. As with the embodiments of FIGS. 1-7, a lift 801 may be activated to force a lower compression member 815 upward from a stable floor 827 and toward a ceiling 829 of the engagement mechanism 800. As such, the mobile device 850 may be secured against an upper compression member 810 below the ceiling 829. Such members 810, 815 may be of conventional compliant materials being up to about 50% compressible in profile. As such, the engagement mechanism 800 may receive or ‘latitudinally’ accommodate and immobily secure any number of mobile devices 850 of a variety of differing shapes and dimensions.

Continuing with reference to FIG. 8, features of the depicted embodiment are provided in addition to those of the embodiments of FIGS. 1-7. For example, as with the embodiments of FIGS. 1-7, data may be pulled from or supplied to the secured mobile device 850 and employed in conjunction with an associated stationary apparatus such as a car stereo. However, in the embodiment of FIG. 8, the stationary apparatus and engagement mechanism 800 may also simultaneously supply power to the mobile device 850 in a wireless manner as detailed below. Thus, concern over battery life of the mobile device 850 may be minimized, particularly where the device 850 is docked for use over an extended period of time.

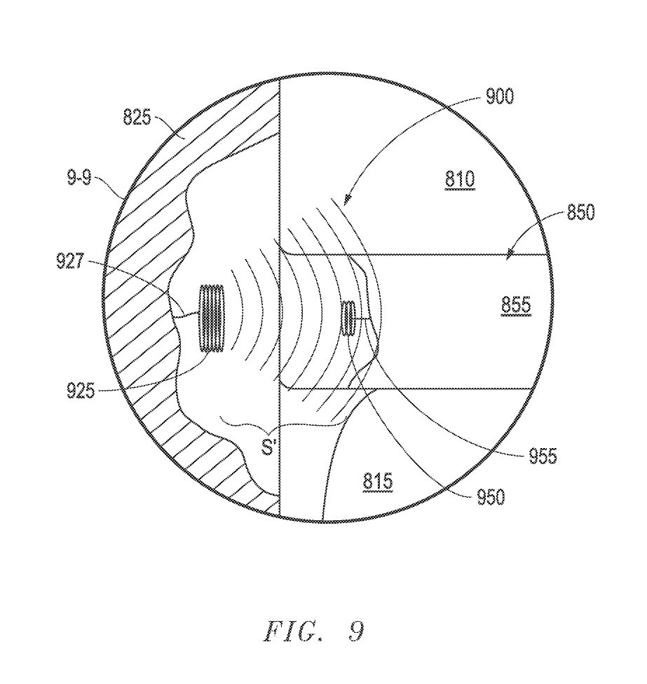

As shown in FIG. 8, the mobile device 850 is configured to rest adjacent, and/or abut, the component or ‘primary’ housing 825 when secured by the engagement mechanism 800 as described above. Thus, the housing 825 may double as a strain gauge beam or another sensor mechanism may be provided as an indicator of device 850 positioning (e.g. for initiation of compression and retention as described above). Regardless, as depicted in FIG. 9, the component housing 825 is equipped with a primary coil 925 as for inductive powering as described below. Along these lines, the mobile device 850 is similarly equipped with a conventional secondary coil 950 within a power reception or ‘secondary’ housing 855 of the device 850. This housing 855 is located for positioning adjacent the component housing 825 of the engagement mechanism 800. Thus, the secondary coil 950 is well positioned for wirelessly obtaining power (inductively impaired voltage) from the primary coil 925.

Referring now to FIG. 9, an enlarged view of the engagement mechanism 800 is shown taken from 9-9 of FIG. 8. In this view, wireless power transfer to the mobile device 850 is represented with a magnetically induced inductive field 900 generated by a primary coil 925. A variety of different electronic architectural designs may be employed for generation of such an inductive field 900 from which a conventional secondary coil 950 may extract and transfer power. Such designs are detailed in U.S. Pat. No. 7,239,110; US 2006/0043927; U.S. Pat. Nos. 7,109,602; 6,906,495; 7,042,196; 6,006,304; 7,462,951; US 2007/0141860 and others. Yet, regardless of the particular design selected, a fundamental principle is employed whereby primary and secondary circuits (i.e. coils 925, 950) of a transformer may be separated by a short distance yet remain magnetically coupled for purposes of power transfer.

In the embodiment of FIG. 9, the primary coil 925 may be a conventional electrical coil with a primary extension 927 that is electronically coupled to circuitry within the component housing 825 and ultimately to a power source of a stationary apparatus. In the embodiment of FIGS. 8-10, the stationary apparatus is a vehicle, whereas the engagement mechanism 800 is incorporated into a console thereof (i.e. docking station 1000). Therefore, a battery integral with the stationary apparatus (e.g. a conventional 100-120V AC or 10-15V DC car battery) may serve as the power source to which the primary coil 925 is ultimately coupled. Indeed, this same type of power source may provide electronic power to the vehicle for a host of other applications, including powering of the lift 801 and other features of the engagement mechanism 800 itself. In the embodiment of FIG. 9, the car battery power source may supply up to several volts to the primary coil 925 for generation of the depicted electromagnetic field 900. As described below, this may translate to a constant supply of voltage ultimately relayed by the secondary coil 950 to a secondary extension 955 through the power reception housing 855 and to a battery of the mobile device 850.

As alluded to, the secondary coil 950 is configured to convert power from the field 900 back into usable electricity, for example, a constant supply of about 1 volt. Such voltage may remain constant whenever the power source is activated and the mobile device 950 secured by the engagement mechanism 800 (see FIGS. 8 & 10). So, for example, in the embodiments of FIGS. 8-10, power to the mobile device 850 may be supplied at any time the device 850 is plugged into the engagement mechanism 800 and the vehicle is turned on. Furthermore, the secondary extension 955 may lead to circuitry that terminates at a battery of the device 850 or a recharging station thereof. Alternatively, the supplied voltage may be used to directly power the mobile device 850 irrespective of also being employed for recharging of the battery of the device 850.

In one embodiment, the mobile device 850 is configured without a separate battery at all. In such an embodiment, wireless powering as described may be the sole source of utilizing the mobile device 850. In another embodiment, the mobile device 850 may be employed only in conjunction with the particular engagement mechanism 800 and docking station 1000 (see FIG. 10). Such an embodiment may be provided as a matter of enhanced security with the mobile device 850 and/or the engagement mechanism 800 programmed with a unique identification feature or ‘protocol’ as a prerequisite to allowing the powered communicative engagement. Nevertheless, the user may still be able to select the particular mobile device 850 of his/her choosing due to the latitudinal reception feature of the engagement mechanism 800. However, once selected, the identification protocol pairing between the device 850 and mechanism 800 may be established.

Continuing with reference to FIG. 9, with additional reference to FIG. 8, the electromagnetic field 900 may be generally considered ‘near field’. That is, the effectiveness of the field 900 may rapidly dissipate moving away from the primary coil 925. Thus, as described below, the separation (s′) between coils 925, 950 may generally be a matter of inches at the most. Thus, concerns over dampening, diffusion, atmospheric absorption and other standard energy losses in such a near field configuration are largely insignificant.

In spite of the rapid dissipation noted above, given that an electromagnetic field 900 is generated, safety concerns may be addressed by shielding that may be provided by the particular environment of the engagement mechanism 800. For example, the nature of the engagement mechanism 800 of the embodiment shown is such that the electromagnetic field 900 is generated substantially within a cavity. That is, the field 900 is surrounded by a structural ceiling 829, floor 827, housing 825 and other features that may naturally offer a degree of shielding. Additionally, such structure may be reinforced with added electromagnetic shielding where appropriate. As a result, the engagement mechanism 800 may serve as an electromagnetic shielding cavity. Thus, where a docking station is employed with a mechanism 800 and field 900 in closer proximity to a user, safety concerns may be sufficiently addressed. For example, applications utilizing such a docking station as part of a backpack or other personal carriage may be employed without significant health concern.

Measures may be taken in order to enhance the efficiency of the above detailed power transfer. For example, the above noted structural shielding may also provide a degree of collimating relative to the generated field 900. Furthermore, the induction itself may be of a resonant variety. That is, the primary coil 925 may be configured to ‘tunnel’ the field 900 at a particular frequency whereas the secondary coil 195 is configured to resonate at about the same frequency. Thus, efficiency of the voltage transfer to the secondary coil 950 may be enhanced. Indeed, while the separation s′ between the coils 925, 955 is unlikely to be more than about an inch or so in the embodiment of FIG. 9, in embodiments where resonant induction is employed, it may actually exceed several inches without concern over effective power transfer.

Continuing with reference to FIGS. 8 and 9, other forms of wireless power transfer may be employed between the engagement mechanism 800 and the mobile device 850. In this context, the term “wireless power transfer” means that power may be transferred from the engagement mechanism 800 to the mobile device 850 without a requirement of true wiring therebetween or any particular matched physical coupling for that matter (e.g. such as the interfacing of a given pin configuration). This may be achieved through inductive power transfer as described or other techniques which continue to allow for latitudinal reception and subsequent stable immobility of the mobile device 850 by the engagement mechanism 800 as detailed above. Such alternate techniques to inductive power transfer may include radio wave transmission, microwave transmission, and laser beaming. Additionally, physical interfacing may actually be allowed between a conductive face of the component housing 825 and a corresponding conductive face of the power reception housing 855. As defined herein, such a power transfer technique may be ‘wireless’ in that no particular matched or interlocking power coupling is utilized between the described conductive faces.

Referring now to FIG. 10, a perspective view of the engagement mechanism 800 is depicted as incorporated into a docking station 1000 which serves as a vehicle console. The engagement mechanism 800 accommodates the mobile device 850 as described above. Additionally, in the embodiment shown, the engagement mechanism 800 and docking station 800 are positioned such that the device 850 is oriented with the display 875 readily visible to a user. That is, assuming a user in a vehicle and seated adjacent the console docking station 1000, the display 875 may be readily apparent when the device 850 is secured as depicted. As such, information such as an incoming call or time (as shown) may be easily visible to the user at the display 875.

The console docking station 1000 of FIG. 10 is equipped with standard features such as cup-holders 1075 and a gear shifter 1025. Additionally, in the embodiment shown, the docking station 1000 also includes a powering engagement 1001 for powerably accommodating another type of mobile device 1050. That is, the powering engagement 1001 may constitute a second engagement mechanism for accommodating an additional device 1050. In the embodiment shown, the additional device 1050 is a flashlight with its own power reception housing 1055 configured to obtain power as detailed above.

Given that the additional device 1050 is unintelligent, lacking in data storage or updating capacity, no wireless communication may be present with the powering engagement 1001 or docking station 1001. Alternatively, however, standard RFID, bar code or other identification techniques may be employed to provide information as to the type of device 1050 or particular device 1050 docked at the engagement 1001. This may differ from the engagement 800 of the other ‘intelligent’ mobile device 850 where execution of a more sophisticated pre-programmed identification protocol may take place.

In the depiction of FIG. 10, it is apparent that the additional device 1050 is a relatively bulky unintelligent tool as compared to the smaller mobile device 850. As a result, the engagement 1001 for the additional device 1050 may be of larger dimension than the engagement mechanism 800 for accommodating the smaller mobile 850. Indeed, as described above, the engagement mechanism 800, 125 may have a cavity 127 that reaches about one inch in height (h) (see FIG. 2). By comparison, the cavity of the powering engagement 1001 may be well in excess of an inch, note d′, in advance of accommodating the larger device 1050. Furthermore, secure accommodation of such a larger device 1050 may be aided by a supplemental securing mechanism within the engagement 1001 such as hook and loop fastening (e.g. Velcro®) or inflation of the compression members defining the cavity. Such mechanisms may provide or supplement the security afforded by the compressive forces of retention as detailed above. Indeed, even gravity may serve as a factor in achieving secure immobilization (e.g. see FIG. 11).

Unlike a conventional recharging station, the powering engagement 1001 is configured for latitudinal reception of larger, generally unintelligent devices such as the depicted flashlight. As described above, there is no requirement of any physically matched coupling, such as the use of a pin configuration or standard metal prong plug, in order to transfer power to the device 1050. Thus, a host of differently shaped and sized devices may be retained by the engagement 1001 for providing power thereto. Furthermore, as noted, this may be achieved without concern over a particular brand or type of matching coupling. So long as the device is equipped with a power reception housing 1055, power transfer thereto may be achieved. Indeed, in one embodiment, the smaller mobile device 850 may even be thrown into the engagement 1001 for powering thereof.

Other types of devices which may be accommodated by the engagement 1001 may include power tools, larger audio communication devices such as walkie talkies and other communication radios (i.e. cb's and other non-walkie talkies), and passive industrial equipment such as sensors. In one embodiment, the engagement 1001 is incorporated into a larger docking station, for example, at a glove box, truck bed, or other appropriate non-vehicular location so as to accommodate such larger devices in a more user-friendly manner. Regardless, the devices remain latitudinally accommodated and immobily retained by the engagement 1001 for powering/recharging purposes.

Referring now to FIG. 11, a side view of another alternate embodiment of docking station and engagement mechanism 1100 is shown. In this embodiment, the mechanism 1100 is configured for powerably accommodating additional differing mobile device types such as the depicted overhead lights (devices 1150, 1151). In this embodiment, the engagement mechanism 1100 is incorporated into a stationary apparatus in the form of an architectural platform such as at a ceiling 1160 whereas mobile devices 1150, 1151 constitute the noted lights.

While such a combination of engagement mechanism 1100 and mobile devices 1150, 1151 appears to be in stark contrast to other embodiments of FIGS. 1-10, the mechanics are, nevertheless similar, particularly to the powering engagement 1001 embodiment of FIG. 10. For example, while the mobile devices 1150, 1151 include power reception housings 1111, 1116 for securing within the engagement mechanism 1100. Further, while the devices 1150, 1151 may not include communicative capacity, wireless power transfer between a component housing 1101 and the reception housings 1111, 1116 may be achieved (e.g. over an electromagnetically induced inductive field 1102).

Continuing with reference to FIG. 11, the engagement mechanism 1100 is again configured for latitudinal reception of any of a variety of mobile devices 1150, 1151, in this case, a variety of ceiling light types. The devices 1150, 1151 may include suspension assemblies 1110, 1115 that are made up of dimensionally variable housings 1111, 1116 and extensions 1112, 1117. Different types of decorative coverings 1125, 1126 may be coupled to the assemblies 1110, 1115. Nevertheless, as with other embodiments detailed herein, the latitudinal reception afforded by the engagement mechanism 1100 allows for a great deal of dimensional variability from device 1150 to device 1151.

As shown in FIG. 11, a device 1150 may be latitudinally positioned within the mechanism 1100 by placement of the housing 1111 in a cavity 1175 thereof. Similar to embodiments described above, the device 1150 may also be immobily secured in place by the clamping action of the depicted mechanism walls 1180 about the assembly 1110 or via clamping of structural features internal thereof (not shown). Additionally, supplemental securing supports 1170 may be provided to further immobilize the device 1150 in place. These supports 1170 may be Velcro or magnetic features configured for adhering to a corresponding surface of the housing 1111.

Once positioned, inductive or other wireless power transfer techniques may be employed to activate the device 1150, in this case, emitting light therefrom. In the embodiment shown, the power source may be a stand-alone generator or community power grid that is coupled to the architectural structure. Thus, power may ultimately be directed through the ceiling 1160 and wire 1103. The wire is coupled to a component housing 1101 and coil thereof, for generation of the depicted field 1102 as detailed above. The field 1102 may be shielded and/or collimated, for example, by the walls 1180 of the mechanism 1100. Additionally, through techniques also detailed above, the housing 1111 is configured to draw on the field 1102 for conversion to usable voltage that ultimately results in the depicted lighting.

The embodiment of FIG. 11 may be particularly beneficial given the emergence of readily available and fairly inexpensive lighting fixtures, such as mass produced LED assemblies. For example, even at low assembly cost, a certain deal of effort in terms of wiring and rewiring may discourage the change out of such assemblies at a conventional architectural structure. However, the availability of an engagement mechanism 1100 for latitudinal accommodation of a host of dimensionally differing light assemblies (such as devices 1150, 1151), may overcome such concerns. That is, the wireless nature of the mechanism 1100 obviates the need for rewiring and the noted latitudinally receiving character means that exacting device or plug dimensions may also be substantially ignored, thereby allowing for much easier change outs. Thus, the inexpensive and readily available nature of such light assemblies may be more fully taken advantage of.

While the embodiments of FIG. 11 focus on an architectural structure for accommodating mobile devices 1150, 1151 in the form of light fixtures, other types of devices may be well suited for accommodation at such a stationary structure. For example, motion detectors, alarm systems, video surveillance equipment, speakers, video monitors such as for flat panel televisions or computers, and other conventionally ceiling or wall mounted devices (i.e. fixtures) may be latitudinally received and securely immobilized by a powering engagement mechanism 1100 as depicted in FIG. 11.

Embodiments described above provide a unique interface between mobile and stationary apparatuses. The interface allows for a host of mobile device shapes and sizes to be accommodated by the same stationary apparatus via a universal docking station and engagement mechanism thereof. Communication between the stationary and mobile devices may thus commence. Additionally, docking of the mobile device for the sake of powering or recharging may also be provided through the engagement mechanism. That is, even with respect to unintelligent devices such as lights and power tools, the engagement mechanism may employ latitudinal reception in combination with wireless power transfer to obviate the need for cumbersome wired coupling between itself and any number of dimensionally differing devices.

Although exemplary embodiments describe a docking station and engagement mechanism accommodating any of a variety of particular mobile devices, additional embodiments are possible. For example, in certain circumstances, the docking station may be less integrally wired or wirelessly coupled to the stationary apparatus. Furthermore, many changes, modifications, and substitutions may be made without departing from the scope of the described embodiments.

I claim:

1. A docking station comprising structure defining a cavity for at least partially receiving and immobilizing one of a variety of differently sized data storing mobile devices in a pin-free positionally imprecise manner to wirelessly transfer power thereto.

2. The docking station of claim 1 configured to wirelessly extract data from the data storing mobile device.

3. The docking station of claim 1 wherein said structure comprises at least one retention member for compressibly assuring the immobilizing.

4. The docking station of claim 1 wherein said structure comprises a securing mechanism to enhance the immobilizing, said mechanism including a feature selected from a group consisting of hook and loop fastening, magnetism and inflation.

5. The docking station of claim 1 configured for coupling to a stationary apparatus to allow interfacing of the data storing mobile device therewith.

6. The docking station of claim 5 wherein the stationary apparatus is one of a vehicle, vehicle stereo, home stereo, laptop computer, desktop computer, backpack, and television integrally accommodating the docking station.

7. The docking station of claim 6 wherein the vehicle comprises a console adjacent a user in the vehicle, said mobile device equipped with a display, docking station configured to orient the device with the display visible to the user during the receiving and the immobilizing.

8. A docking assembly comprising:
one of a variety of differently dimensioned data storing mobile devices;
a stationary apparatus for wirelessly transferring power to the data storing mobile device when docking; and
a docking station of said stationary apparatus comprising structure defining a cavity for at least partially accommodating said mobile device, said station configured for receiving and immobilizing said device for the docking in a pin-free positionally imprecise manner.

9. The docking assembly of claim 8 wherein said data storing mobile device is one of a smartphone and a phablet.

10. The docking assembly of claim 8 wherein said data storing mobile device comprises an identification feature for allowing one of the transferring of the power and identifying said mobile device to the stationary apparatus.

11. The docking assembly of claim 10 wherein the identification feature includes one of a bar code, RFID, and execution of a pre-programmed identification protocol between said data storing mobile device and said stationary apparatus.

12. The docking assembly of claim 8 wherein said stationary apparatus comprises a power source integral therewith, the wirelessly transferring of power including the mobile device acquiring power from the power source, the structure defining the cavity configured for one of shielding and collimating the wireless power transfer.

13. A method comprising:
at least partially receiving one of a variety of differently sized data storing mobile devices within a cavity of a docking station;
immobilizing the data storing mobile device within the cavity to achieve docking thereof in a pin-free positionally imprecise manner; and
wirelessly transferring power from the docking station to the immobilized device.

14. The method of claim 13 further comprising wirelessly transmitting data between the mobile device and the stationary apparatus, said transmitting comprising the docking station acquiring one of audio information from the mobile device and device identification information from the mobile device.

15. The method of claim 13 wherein said receiving of the data storing mobile device by the docking station allows a portion of the mobile device to remain exposed from the cavity for manual retrieval.

16. The method of claim 13 wherein said receiving of the data storing mobile device by the docking station effects an engagement actuator thereof to initiate said immobilizing.

17. The method of claim 13 wherein said wirelessly transferring power to the device is achieved through one of inductive coupling, radio wave transmission, microwave transmission, laser beaming, and non-interlocking conductive interfacing.

18. The method of claim 17 wherein said transferring is achieved through inductive coupling, the method further comprising:
generating an inductive field with a primary coil of the docking station; and
acquiring power from the field with a secondary coil of the mobile device.

19. The method of claim 18 wherein said generating of the inductive field with the primary coil is at a given frequency, the secondary coil configured to resonate at about the given frequency to support the wireless power transfer.

20. The method of claim 18 further comprising one of directly powering the mobile device with the acquired power, charging a battery of the middle device with the acquired power, and directing the acquired power to a recharging station of the mobile device.
